(19) United States
(12) Patent Application Publication
(10) Pub. No.: US 2010/0318728 A1
(43) Pub. Date: Dec. 16, 2010

(54) SOLID STATE DRIVE DEVICE

(75) Inventors: Min-Soo KANG, Suwon-si (KR); Chuljoon CHOI, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/785,858

(22) Filed: May 24, 2010

(30) Foreign Application Priority Data
Jun. 11, 2009 (KR) 10-2009-0051938

(51) Int. Cl. G06F 12/00; G06F 12/02; G06F 12/14

(52) U.S. Cl. 711/103; 711/164

(57) ABSTRACT

A solid state drive (SSD) device is provided. The SSD device includes: a first memory device storing data; a memory controller, connected to a host, and controlling the memory device; and a security device encoding and storing the data using a key and decoding the stored data using the key, wherein the security device stores the key and is detachable from the memory controller.

### CROSS-REFERENCE TO RELATED APPLICATIONS

This U.S. non-provisional patent application claims priority under 35 U.S.C. §119 from Korean Patent Application No. 10-2009-0051938, filed on Jun. 11, 2009, the entire contents of which are hereby incorporated by reference.

### BACKGROUND

The present disclosure relates to a solid state drive (SSD) device, and more particularly, to an SSD device capable of encoding/decoding data using a smart card.

According to a hard disk drive (HDD) trend, a demand on an SSD device adopting a flash memory as a memory device instead of a magnetic disk device has gradually increased. The SSD device as a mass storage of a computer system or a portable device is disadvantageous in terms of memory capacity or cost compared to a magnetic disk device, but is advantageous in terms of access speed, miniaturization, and shock stability. Additionally, as manufacturing techniques and design techniques are being advanced, increases in memory capacity and cost reduction of the SSD device are expected. Thus, the SSD device will likely replace the magnetic disk soon.

If the SSD device is used as a mass storage device of a computer system or of other devices, a control device is required for providing compatibility between data exchange protocols of a host and a flash memory.

In a typical computer system, an advanced technology attachment (ATA) standard for an HDD, suggested by IBM in the United States, is used as a data transfer protocol of a disk drive. In order to achieve the above protocol compatibility, an interface for data exchange in an ATA method and an interface with a flash memory are necessary. A device for controlling general operations of the data exchange is referred to as an SSD controller.

### SUMMARY

The present disclosure provides a solid state drive (SSD) device with a smart card integrated circuit (IC).

Illustrative embodiments provide SSD devices including: a first memory device storing data; a memory controller, connected to a host, controlling the memory device; and a security device encoding and storing the data using a key and decoding the stored data using the key, wherein the security device stores the key and is detachable from the memory controller.

In some illustrative embodiments, the security device may include a smart card, the smart card including one of a subscriber identity module (SIM) card, a universal-subscriber identity module (U-SIM) card, and a Euro Master Visa (EMV) card.

In other illustrative embodiments, the security device may include: an encoding unit encoding data by using the key; a decoding unit decoding the encoded data by using the key; a second memory device storing the key; and a security management program managing access rights about the first memory device.

In still other illustrative embodiments, the security device may include a smart card web server accessing the security management program and the key through an internet protocol.

In even other illustrative embodiments, the first memory device may store a portion of the data and the second memory device stores the remaining data.

In yet other illustrative embodiments, the first memory device may include a flash memory device, wherein the memory controller include: a host interface providing an interface to the host; an input/output interface providing an interface with the security device; a flash memory controller controlling the flash memory device; and a core controlling the host interface, the input/output interface, and the flash memory controller.

In further illustrative embodiments, the input/output interface may provide at least one of a universal serial bus (USB) 2.0 protocol, an interchip (IC)-USB protocol, and a multi media card (MMC) protocol.

In still further illustrative embodiments, the core may include: a host interface layer unit controlling the host interface; a cache allocation layer unit controlling the buffer manager; a flash translation layer unit controlling a flash translation layer (FTL) of the flash memory controller; and a flash interface layer unit controlling an interface with the flash memory.

In even further illustrative embodiments, the core may include an ARM® processor.

### BRIEF DESCRIPTION OF THE DRAWINGS

The accompanying drawings are included to provide a further understanding of illustrative embodiments, and are incorporated in and constitute a part of this specification. The drawings illustrate exemplary embodiments and, together with the description, serve to explain principles of such embodiments. In the drawings:

FIG. 1 is a block diagram illustrating a solid state drive (SSD) device and a host connected thereto according to an illustrative embodiment;

FIG. 2 is a block diagram illustrating the smart card IC 125 of FIG. 1;

FIG. 3 is a block diagram illustrating the core 128 of FIG. 1;

FIG. 4 is a block diagram illustrating an SSD device and a host connected thereto according to an illustrative embodiment;

FIG. 5 is a block diagram illustrating a hard disk device and a host connected thereto according to an illustrative embodiment; and

FIG. 6 is a block diagram illustrating an optical disk device and a host connected thereto according to an illustrative embodiment.

### DETAILED DESCRIPTION OF ILLUSTRATIVE EMBODIMENTS

Hereinafter, illustrative embodiments will be described with reference to the drawings such that those skilled in the art realize the scope such illustrative embodiments without difficulties.

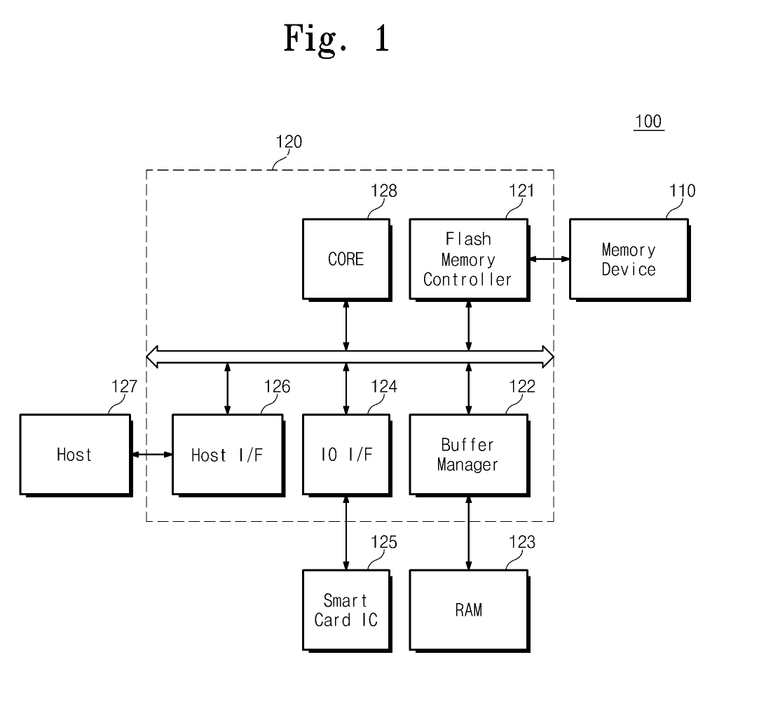

FIG. 1 is a block diagram illustrating a solid state drive (SSD) device and a host connected thereto according to an illustrative embodiment.

Referring to FIG. 1, an SSD device 100 includes a memory device 110 and a memory controller 120 for controlling the memory device 110. The memory device 110 is configured to store a large amount of data as a secondary storage. Generally, a secondary storage device includes a hard disk drive (HDD), an optical disk drive (ODD), etc., but the memory device 110 includes a flash memory in this illustrative embodiment.

The memory controller 120 includes a flash memory controller 121, a buffer manager 122, an input/output interface 124, a host interface 126, and a core 128. The flash memory controller 121 controls flash memories in the memory device 110.

The buffer manager 122 controls the RAM 123. The RAM 123 serves as a buffer for temporarily storing data to be transmitted into the host 127, or temporarily stores data transmitted from the host 127 in the memory device 110. The RAM 123 is realized, for example, with a dynamic random access memory (DRAM).

The input/output interface 124 connects a security device with the flash memory controller 121.

As an illustrative embodiment, the security device uses a smart card integrated circuit (IC) 125 as one example.

Basically, the smart card IC 125 transmits data according to an ISO 7816 protocol. Moreover, the high-performance smart card IC 125 supports a multimedia card (MMC) protocol, a universal serial bus (USB) 2.0 protocol, and an interchip universal serial bus (IC-USB), which can transmit data at a high speed, in addition to the ISO 7816 protocol. The smart card IC 125 according to an illustrative embodiment supports the IC USB protocol, for example. Accordingly, the input/output interface 125 supports an IC-USB protocol. Moreover, the input/output interface 124 supports the MMC protocol, the USB 2.0 protocol, etc. The smart card IC 125 may be connected to or separated from the SSD device 100.

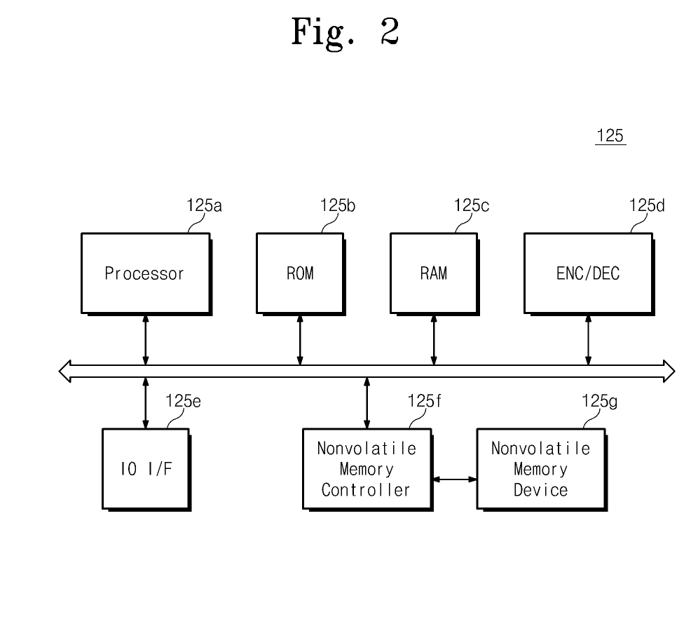

The smart card IC 125 will be described in more detail with reference to FIG. 2. That is, the inner blocks of the smart card IC 125 will be described in FIG. 2.

FIG. 2 is a block diagram illustrating the smart card IC 125 of FIG. 1.

Referring to FIGS. 1 and 2, the smart card IC 125 includes a processor 125a, a read only memory (ROM) 125b, a random access memory (RAM), an encoding/decoding unit 125d, an input/output interface 125e, a nonvolatile memory controller 125f, and a nonvolatile memory device 125g.

The processor 125a controls the ROM 125b, the RAM 125c, the encoding/decoding unit 125d, the input/output interface 125e, and the nonvolatile memory controller 125f. The ROM 125b or the nonvolatile memory device 125g store an operating system of the smart card IC 125. The RAM 125c temporarily stores commands or data, which will be used for the processor 125a. The encoding/decoding unit 125d performs encryption on inputted data and performs decryption on the encrypted data. The input/output interface 125e connects the smart card IC 125 with the SSD device 100. The nonvolatile memory controller 125f controls the nonvolatile memory device 125g to store data and to read the stored data.

The nonvolatile memory device 125g stores a key that will be used in the encoding/decoding unit 125d. Moreover, the nonvolatile memory device 125g stores information (for example, financial information) necessary for the smart card IC 125.

When the smart card IC 125 is connected to the SSD device 100, the SSD device is connected to the memory controller 125f through the input/output interface 124. The encoding/decoding unit 125d encodes the data stored in the memory device 110, using a key. Additionally, the encoding/decoding unit 125d protects the data read from the memory device 110, using a key.

If the smart card IC 125 is separated from the SSD device 100, the SSD device 100 cannot decode the encoded data stored in the memory device 110. That is, the SSD device 100 does not have encoding and decoding functions and does not store the key used for the encryption and decryption of the data. In this case, the SSD 100 reads the encoded data as is. Accordingly, an illustrative embodiment manages security of the SSD device 100 by connecting or separating the smart card IC 125.

If the smart card IC 125 is separated from the SSD device 100, the SSD device 100 cannot encode the data inputted from the host 127 and stores the data in the memory device 110. Additionally, the SSD device 100 transmits encoded data to the host 127. That is, the SSD device 100 does not perform encryption or decryption operations and just performs a write or read operation on data.

Referring to FIG. 1, the host interface 126 mutually connects the memory device 110 and the host 127. For example, the interface 126 may be a serial advanced technology attachment (S-ATA) interface. Or, for example, the host interface 126 may include at least one of a parallel advanced technology attachment (P-ATA), a USB, and a peripheral component interconnect (PCI).

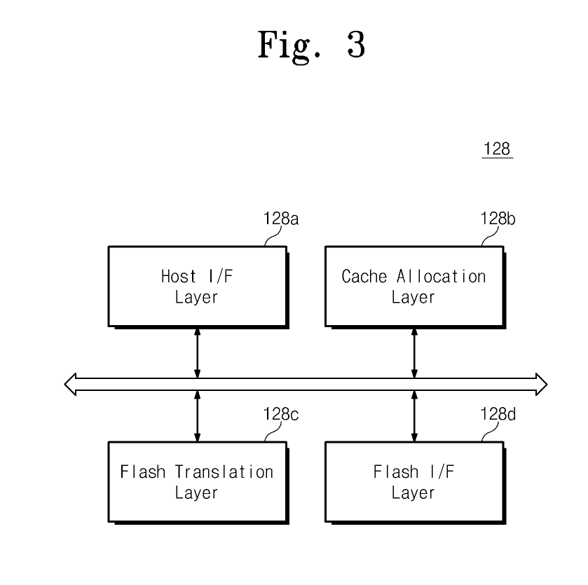

The core 128 controls the flash memory controller 121, the buffer manager 122, the input/output interface 124, and the host interface 126. In general, the core 128 is realized with ARM7TDMI® of an ARM® company. The core 128 according to an illustrative embodiment will be described in more detail through FIG. 3.

FIG. 3 is a block diagram illustrating the core of FIG. 1.

Referring to FIGS. 1 and 3, an illustrative embodiment uses a memory controller 120 including a single core as one example. The core 128 includes a host interface layer 128a, a cache allocation layer 128b, a flash translation layer 128c, and a flash interface layer 128d.

The host interface layer 128a controls the host interface 126 to allow the host 127 and the memory controller 120 to interface each other. The cache allocation layer 128b controls the buffer manager 122. The flash translation layer 128c controls a flash translation layer (FTL) of the flashmemory controller 121. The flash interface layer 128d allows the flash memory controller 121 and the memory device 110 to interface each other.

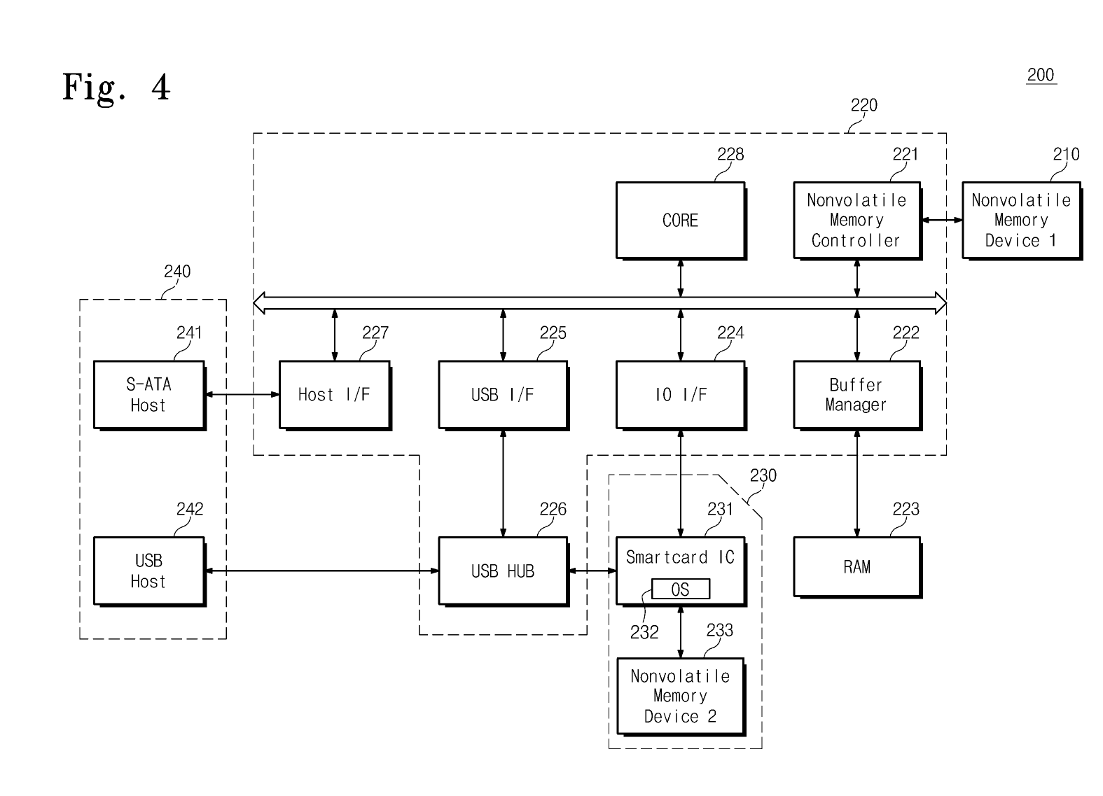

FIG. 4 is a block diagram illustrating an SSD device and a host connected thereto according to an illustrative embodiment.

Referring to FIG. 4, an SSD 200 device includes a first nonvolatile memory device 210 and a memory controller 220 for controlling the first nonvolatile memory device 210. The first nonvolatile memory device 210 is configured to store a large amount of data as a secondary storage. As an illustrative embodiment, the first nonvolatile memory device 210 includes a flash memory device (not shown).

The memory controller 220 includes a nonvolatile memory controller 221, a buffer manager 222, a RAM 223, an input/output interface 224, a USB interface 225, a USB hub 226, a host interface 227, and a core 228. The nonvolatile memory controller 221 controls flash memories in the first nonvolatile memory device 210. The buffer manager 222 controls the RAM 223. The RAM serves as a buffer to temporarily store data to be transmitted into the host 240 or to temporarily store data transmitted from the host 240 in the first nonvolatile memory device 210. The RAM 223 is realized, for example, with a DRAM. The input/output interface 224 connects a security device with the memory controller 220. As an illustrative embodiment, the security device uses a universal-subscriber identity module (U-SIM) card 230 as one example. In addition, the security device may include, for example, a subscriber identity module (SIM) card and a Euro Master Visa (EMV) card. The EMV card is a standard of an IC card that is for authenticating payments by an interoperation of Euro pay of Belgium and MasterCard and VISA of the United States, i.e., three worldwide credit card companies. Basically, the U-SIM card 230 transmits data according to ISO 7816.

The U-SIM card 230 supports the MMC protocol, the USB 2.0 protocol, and the IC-USB, which can transmit data at a high speed, in addition to the ISO 7816 protocol. As an illustrative embodiment, the U-SIM card 230 supports the ISO 7816 protocol and the IC-USB protocol. Accordingly, the input/output interface 224 supports any one of the ISO 7816 protocol, the MMC protocol, the USB 2.0 protocol, and the IC-USB protocol. The U-SIM card 230 includes a smart card IC 231 and a second nonvolatile memory device 233. The smart card IC 231 includes an operating system 232 for operating the smart card IC 231.

The smart card IC 231 includes inner functional blocks analogous to those in the smart card IC 125 of FIG. 2. For example, the smart card IC 231 may include the inner functional blocks for encoding data and decoding the encoded data, analogous to the smart card IC 125 shown in FIG. 2. Accordingly, the smart card IC 231 encodes data transmitted from a host, using a key. The nonvolatile memory controller 221 stores the encoded data in the first nonvolatile memory device 210. In addition, the smart card IC 231 decodes the encoded data stored in the first nonvolatile memory device 210, using a key. The core 228 transmits the decoded data to the host 240.

The operating system 232 is stored in a ROM or a nonvolatile memory device analogous to the ROM 125b or the nonvolatile memory device 125g shown in FIG. 2. The second nonvolatile memory device 233 is configured to store a large amount of data. As an illustrative embodiment, the second nonvolatile memory device 233 includes a flash memory device. The U-SIM card 230 may be connected to or separated from the SSD device 200.

For example, when the U-SIM card 230 is connected to the SSD device 200, it is connected to the memory controller 220 through the input/output interface 224. The smart card IC 231 encodes data stored in the first nonvolatile memory device 210, using a key. In addition, the smart card IC 231 decodes the encoded data read from the first nonvolatile memory device 210, using the key. The smart card IC 231 stores a list of encoded data in the second nonvolatile memory device 233.

The USB host 242 transmits a command for controlling an encoding or decoding operation into the smart card IC 231 through the USB hub 226. The smart card IC 231 performs encryption on data inputted from the host 240 in response to a command transmitted through the USB hub 226.

If the U-SIM card 230 is separated from the SSD device 200, the SSD device 200 decodes the encrypted data stored in the first nonvolatile memory device 210. Accordingly, an illustrative embodiment manages security of the SSD device 200 by connecting or separating the U-SIM card 230.

If the U-SIM card 230 is separated from the SSD device 200, the SSD device 200 does not encode the data inputted from the host 240 and stores such data in the first nonvolatile memory device 210. Additionally, the SSD device 200 transmits the encoded data to the host 240. That is, the SSD device 200 does not perform an encryption or decryption operation on the data and, instead, performs a write or read operation on the data.

In addition, a portion of data encoded by the smart card IC 231 is stored in the first nonvolatile memory device 210 and the remaining data are stored in the second nonvolatile memory device 233. Accordingly, if the U-SIM card 230 is separated from the SSD 200, it is impossible to decode the encoded data.

The USB interface 225 interfaces with the USB hub 226. The USB hub 226 connects the USB host 242 and the smart card IC 231. The host interface 227 connects the first nonvolatile memory device 210 and the S-ATA host 241 mutually. As an illustrative embodiment, the interface 227 includes a S-ATA interface, for example.

The core 228 controls the nonvolatile memory controller 221, the buffer manager 222, the input/output interface 224, the USB interface 225, the USB hub 226, and the host interface 227. The core 228 includes functional blocks analogous to those shown in FIG. 3.

An illustrative embodiment divides an arbitrary file A and stores the divided files in the first and second nonvolatile memory devices 210 and 233.

For example, only a portion of a header of the file A is stored in the second nonvolatile memory device 233 and the remaining data of the file A are stored in the first nonvolatile memory device 210. That is, metadata of the file A are stored in the second nonvolatile memory device 233 and the remaining data of the file A are stored in the first nonvolatile memory device 210. Accordingly, if the U-SIM card 230 is separated, the file A cannot be read.

Referring to FIG. 4, the operating system 232 includes a smart card web server (SCWS). Recently, as a capacity of the U-SIM card 230 is increased, the SCWS is loaded in the U-SIM card 230. Thus, because the SCWS is embedded in the U-SIM card 230, the contents in the U-SIM card 230 can be accessed through an internet protocol, using a web browser embedded in a mobile phone. Conditional access system (CAS) software restricts access rights about a channel of a mobile television (e.g., a satellite Digital Multimedia Broadcasting), or a pay TV (e.g., a pay broadcasting program of Internet Protocol Television). That is, an illustrative embodiment realizes security management software in a smart card like the CAS software, which can restrict access rights about a specific region of the SSD device 200.

The SSD device 200 provides service similar to over-the-air security management software by using the smart card IC 231 connected to the USB hub 226. The “OTA” stands for “over-the-air,” and is a technique for transmitting and receiving information related to an application via a wireless network.

The U-SIM card 230 executes a SCWS program after booting with the operating system 232, and loads security management software for restricting access rights about a specific region of the SSD 200. The host 240 is connected to the USB hub 226 through the USB host 242. The USB hub 226 connects the USB host 240 and the smart card IC 231. The host 240 can access the security management program of the smart card IC 231 through the USB hub 226. For example, the host 240 copies and updates the key of the smart card IC 231. In addition, if the host 240 is connected to the web, an administrator of the host 240 can update a security management program of the smart card IC 231 through an internet protocol.

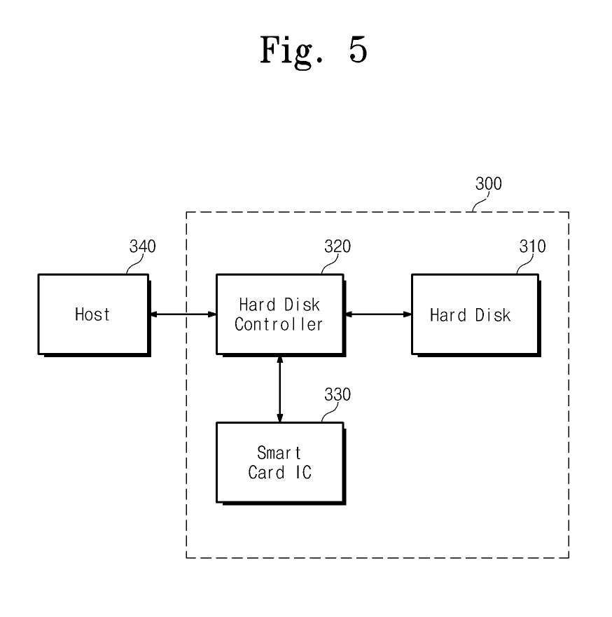

FIG. 5 is a block diagram illustrating a hard disk device and a host connected thereto according to an illustrative embodiment.

Referring to FIG. 5, the hard disk device 300 includes a hard disk 310, a hard disk controller 320, and a smart card IC 330.

As an illustrative embodiment, the hard disk device 300 allows the hard disk 310 to store a large amount of data. The hard disk controller 320 controls the hard disk 310. The host 340 accesses the hard disk 310 through the hard disk controller 320. The smart card IC 330 is connected to or separated from the hard disk controller 320.

For example, if the smart card IC 330 is connected to the hard disk controller 320, the smart card IC 330 uses a key to encode data. The encoded data are stored in the hard disk 310. In addition, the smart card IC 330 decodes the encoded data read from the hard disk 310, using the key.

If the smart card IC 330 is separated from the hard disk controller 320, the hard disk controller 320 cannot decode and read the encoded data stored in the hard disk 310. Accordingly, an illustrative embodiment manages security of the hard disk device 300 by connecting or separating the smart card IC 330.

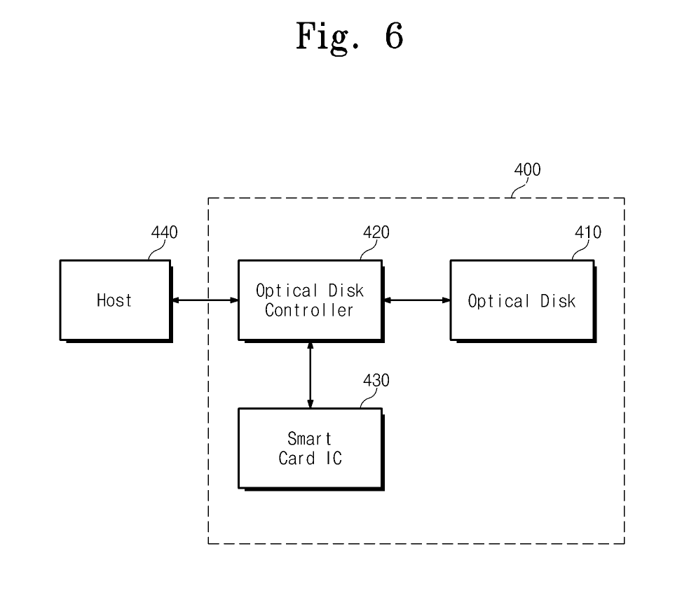

FIG. 6 is a block diagram illustrating an optical disk device and a host connected thereto according to an illustrative embodiment.

Referring to FIG. 6, the optical disk device 400 includes an optical disk 410, an optical disk controller 420, and a smart card IC 430.

As an illustrative embodiment, the optical disk device 400 includes, but is not limited to, CD-R, CD-RW, DVD-R, DVD+R, DVD-RW, DVD+RW, and DVD-RAM.

The optical disk 410 is configured to store a large amount of data. The optical disk controller 420 controls the optical disk 410. A host 440 accesses the optical disk 410 through the optical disk controller 420. The smart card IC 430 is connected to or separated from the optical disk controller 420.

For example, if the smart card IC 430 is connected to the optical disk controller 420, the smart card IC 430 uses a key to encode data. The encoded data are stored in the optical disk 410. Moreover, the smart card IC 430 decodes the data read from the optical disk 410, using the key.

If the smart card IC 430 is separated from the optical disk controller 420, the optical disk controller 420 cannot decode and read the encoded data stored in the optical disk 410. Accordingly, an illustrative embodiment manages security of the optical disk device 400 by connecting or separating the smart card IC 430.

The SSD device according to an illustrative embodiment is capable of encoding and decoding data using a smart card.

The above-disclosed subject matter is to be considered illustrative and not restrictive, and the appended claims are intended to cover all such modifications, enhancements, and other illustrative embodiments, which fall within the true spirit and scope of the inventive concept as defined by the appended claims. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A solid state drive (SSD) device comprising:
a first memory device configured to store data;
a memory controller, connected to a host, the memory controller being configured to control the first memory device; and
a security device configured to encode data using a key and to enable the encoded data to be stored in the first memory device,
wherein the security device is configured to decode the stored encoded data using the key,
wherein the security device stores the key, and
wherein the security device is connectable to and detachable from the memory controller.

2. The SSD device of claim 1, wherein the security device comprises a smart card, the smart card including one of: a subscriber identity module (SIM) card, a universal-subscriber identity module (U-SIM) card, and an Euro Master Visa (EMV) card.

3. The SSD device of claim 1, wherein the security device comprises:
an encoding unit configured to encode data by using the key;
a decoding unit configured to decode the encoded data by using the key;
a second memory device storing the key; and
a security management unit configured to manage access rights of the first memory device.

4. The SSD device of claim 3, wherein the security device comprises a smart card web server unit configured to access the security management unit and the key using an internet protocol.

5. The SSD device of claim 3, wherein the first memory device is configured to store a portion of a data file and the second memory device is configured to store a remainder of the data file.

6. The SSD device of claim 1, wherein the first memory device comprises a flash memory device, and
wherein the memory controller comprises:
a host interface configured to provide an interface to the host;
a buffer manager configured to control a RAM;
an input/output interface configured to provide an interface with the security device;
a flash memory controller configured to control the flash memory device; and
a core configured to control the host interface, the input/output interface, and the flash memory controller.

7. The SSD device of claim 6, wherein the input/output interface is configured to provide at least one of: a universal serial bus (USB) 2.0 protocol, an interchip (IC)-USB protocol, and a multi media card (MMC) protocol.

8. The SSD device of claim 6, wherein the core comprises:
a host interface layer unit configured to control the host interface;
a cache allocation layer unit configured to control the buffer manager;
a flash translation layer unit configured to control a flash translation layer (FTL) of the flash memory controller; and
a flash interface layer unit configured to control an interface with the flash memory.

9. The SSD device of claim 8, wherein the core comprises an ARM® processor.

10. The SSD device of claim 1, wherein if the security device is connected to the memory controller, then the memory controller is enabled to decode the encoded data stored in the first memory device.

11. The SSD device of claim 10, wherein if the security device is detached from the memory controller, then the memory controller is disabled from decoding the encoded data stored in the first memory device.

12. The SSD device of claim 1, wherein if the security device is connected to the memory controller, then the memory controller is enabled to encode data from the host, to store the encoded data from the host in the first memory device, and to decode the encoded data stored in the first memory device.

13. The SSD device of claim 12, wherein if the security device is detached from the memory controller, then the memory controller is disabled from encoding data from the host.

14. The SSD device of claim 13, wherein if the security device is detached from the memory controller, then the memory controller is disabled from decoding the encoded data stored in the first memory device.

15. The SSD device of claim 5, wherein if the security device is connected to the memory controller, then the memory controller is enabled to read the entire data file.

16. The SSD device of claim 15, wherein if the security device is detached from the memory controller, then the memory controller is disabled from reading the entire data file.

17. A data storage system comprising:
a first solid state memory device configured to store data;
a memory controller configured to control the first solid state memory device;
wherein the memory controller is configured to receive data from a host;
a security device;
wherein the security device is configured to encode data using a key,
wherein the security device is configured to enable the encoded data to be stored in the first solid state memory device,
wherein the security device is configured to decode the encoded data using the key,
wherein the security device stores the key, and
wherein the security device is connectable to and detachable from the memory controller.
